(19) United States
(12) Patent Application Publication
(10) Pub. No.: US 2002/0038219 A1
(43) Pub. Date: Mar. 28, 2002

(54) Matching and communication method and system

(76) Inventors: Hamutal Yanay, Buchshrieber, Or-Yehuda (IL); Yaara Yanay, Ramat-Gan (IL)

Correspondence Address: William H. Dippert, Cowan, Liebowitz & Latman, P.C., 1133 Avenue of the Americas, New York, NY, 10036, US

(21) Appl. No.: 09/910,421

(22) Filed: Jul. 20, 2001

(30) Foreign Application Priority Data
Jul. 24, 2000 (IL) 137464

(51) Int. Cl. G06F 17/60

(52) U.S. Cl. 705/1

(57) ABSTRACT

A method for matching a customer and a Provider, comprises the steps of: a) generating a database containing data relevant to the Provider; b) updating said database so as to keep said data on the Provider up-to-date; c) when a call is received from a customer, identifying the requirements of the customer; d) identifying the nature of the request of the customer for a Provider; e) searching said database for a Provider who fits best the requirements of the customer; and f) when such best fit Provider is found, generating a voice and/or data communication between said customer and said provider.

### FIELD OF THE INVENTION

The present invention relates to a method for the efficient communication between a supplier of services or goods, and a potential customer.

### BACKGROUND OF THE INVENTION

The problem of identifying products suppliers and service providers (hereinafter referred to as “Provider”) that are the most suitable for a potential customer, is a complicated problem. This, because of the many variables involved in selecting a Provider. For instance, the quality and the cost of the services may vary, and different customers may value the services differently.

Certain services have become almost staple services, with a low variability in price and quality. For instance, the delivery of pizza is, in most cases, quite equivalent, independently of the pizza house from which it has been ordered. However, even for such staple services there may be a provider that better matches the customer's needs at a given time, for instance, because it is less busy or closer geographically to the customer. Other examples of services which are pertinent to the subject of the invention are: 1) A messenger needed to pick-up laundry from a customer's house; 2) The closest open pharmacy and the verification by the customer of business hours and/or availability of a drug; 3) The fast-food place closest to a moving customer; 4) The closest available plumber to deal with a bursting pipe.

All the above and other problems are the more acute in a big city with a large number of services from which to choose, and also in cities where distances are great, and arrival time of a given Provider or to it, may be considerable. Although this problem is universal and severe, the art has so far failed to provide an efficient solution to it.

It is therefore an object of this invention to provide a method for optimizing the choice of Provider by a customer.

It is another purpose of this invention is to provide a system for carrying out the method of the invention, which utilizes a communication.

Other purposes and advantages of this invention will appear as the description proceeds.

### SUMMARY OF THE INVENTION

The invention is directed to a method for matching a customer and a Provider, comprising the steps of:

a) generating a database containing data relevant to the Provider;

b) updating said database so as to keep said data on the Provider up-to-date;

c) when a call is received from a customers identifying the requirements of the customer;

d) identifying the nature of the request of the customer for a Providers

e) searching said database for a Provider who fits best the requirements of the customer; and

f) when such best fit Provider is found, generating a voice and/or data communication between said customer and said provider.

The requirements of the customer may be of any type, and they generally put a constraint, or a preference, on the choice of service supplier. In many instances, but not limitatively, said requirements include the geographic location of the customer.

The data relevant to the Provider, kept in the data base, can be of any relevant type and, for example, include the availability status, geographical location and scheduled jobs.

The updating of the database can be initiated either by the Provider, or by the CMS, or by both. According to a preferred embodiment of the invention said updating is initiated by the Providers. According to another preferred embodiment of the invention the updating of the database is initiated by the database by polling the Providers.

Preferably, but non-limitatively, the location of the customer is determined using location systems of the communication network from which the call of the customer is placed. Said communication network can be a cellular phone network, but the customer and/or the Provider can also use a regular telephone line. Either or both of the customer and the Provider can be in motion, or static.

The Provider can be of any type, for instance, can be selected from among food providers, house services providers, personal services providers, delivery services, and information providers.

In another aspect, the invention is directed to a system for matching a customer and a Provider, comprising:

a) a database containing data relevant to the Provider;

b) communication lines and means for updating said database so as to keep sad data on the Provider up-to-date;

c) location apparatus for identifying the geographical location of the customer calling the system;

d) personnel or apparatus for identifying the nature of the request of the customer for a Provider;

e) searching software for searching said database for a Provider who fits best the requirements of the customer; and

i) dialing and switching means for generating a voice and/or data communication between said customer and said provider.

### BRIEF DESCRIPTION OF THE DRAWINGS

FIG. 1 is a schematic representation of a system, according to a preferred embodiment of the invention;

FIG. 2 is a flow sheet of the activities carried out by the Central Matching Server (CMS) 100 of FIG. 1;

### DETAILED DESCRIPTION OF PREFERRED EMBODIMENTS

In the context of this specification, the following terms should be interpreted as follows:

Provider: Any person or location sought by another person requiring services, goods, information, personal contacts, or any other tangible or intangible asset available at or through said person or location;

Customer: Any person seeking services, goods, information, personal contacts, or any other tangible or intangible asset available at or through another person or location;

Communication: Any means to communicate between different persons, or between a person and a location, through a network to which both said person(s) and location belong, including but not limited to cellular phones, wireless Internet terminals, Internet terminals, hand-held computing devices, radio units, etc.

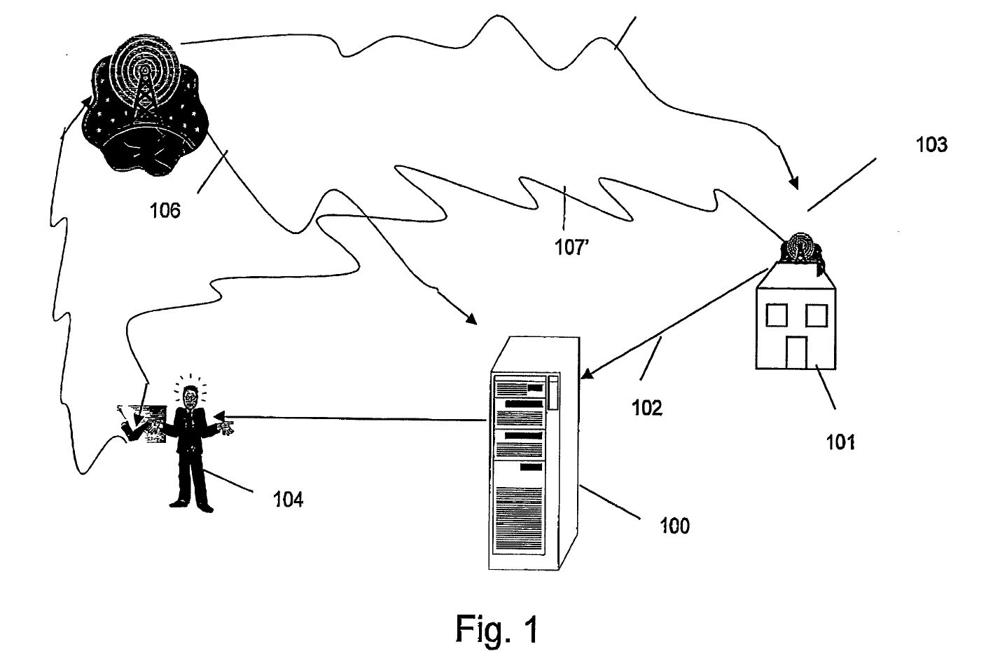

The general concept on which the invention is based is schematically shown in FIG. 1. A central matching server (CMS) 100 contains relevant details of Providers, such as their location, availability, price level, etc., as will be further explained in greater detail hereinafter. In FIG. 1 one such Provider 101 is shown, which may be, e.g., a restaurant. Provider 101 is in communication with CMS 100 via a communication line 102, which can be any suitable communication line, e.g., the Internet or a telephone coupled with a modem. Provider 101 may further provided with communication means 103, compatible with a communication system, e.g., a cellular phone, as shown in the figure, or the communication between it and the customer may be carried out over a regular telephone line.

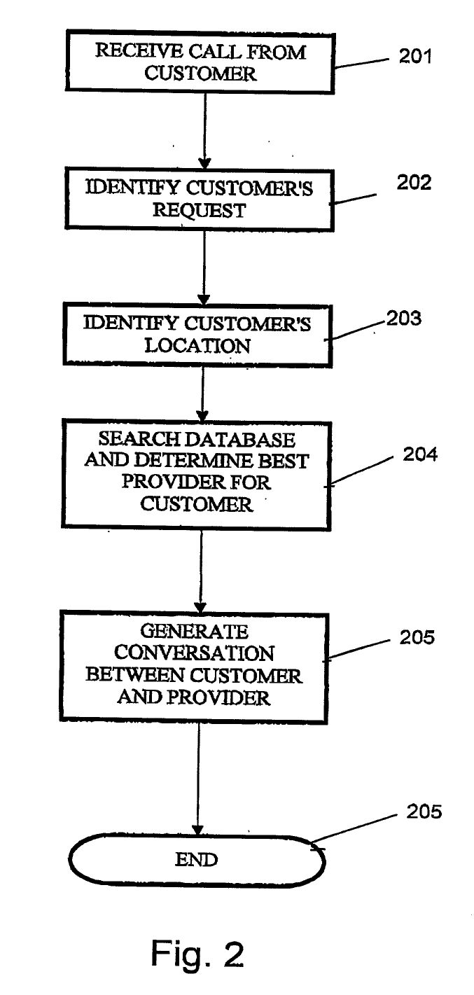

A customer 104, provided with communication means 105, e.g., a cellular phone, wishes, for example, to book a table at a nearby restaurant. Customer 104 dials CMS 100 through his cellular phone 105, as indicated by arrow 106. When he reaches CMS 100 he inputs his request. Inputting the request can be made in any suitable way, e.g., through a manned position that keys-in the request, or by machine-processable input, such as key-board command, or voice-to-text interfaces. Additional specific requirements can also be added by the customer, such as that the restaurant be a vegetarian one. As shown in FIG. 2, Once the CMS receives the call from the customer (Step 201) and his request (Step 202), it carries out the following activities: 1) It locates the geographic position of the customer (Step 203) (using communication system location abilities known per se in the A, which are therefore not discussed herein in detail, for the sake of brevity); 2) It scans its database to determine which Provider is the optimal one for the given customer, based on its distance from said geographic location of the user, and if additional parameters have been specified by the user, based on such specified parameters (Step 204); 3) Once the optimal Provider has been identified, it creates a direct communication between the customer and the provider (lines 107, 107′ in FIG. 1; Step 205 in FIG. 2), and Customer 104 and Provider 101 may then complete their transaction. In the case of the example illustrated in FIG. 1, the transaction will be the booking of a table for the required number of persons and at the appropriate time. The activity of the CMS then end (Step 206).

It should be noted that it is not necessary that both ends (i.e., the customer and the service provider) be provided with a computerized telephone. The phone communication can be initiated either by the customer or by the service provider (whichever has a computerized phone), and can reach a person using a non-computerized phone. It is also possible to input data to the CMS in various ways, e.g., using a living person in the CMS, or using a voice menu.

It is thus appreciated that the invention performs a matching activity, by causing a customer and a Provider to start talking to one another over a communication system. However, the invention is not concerned with the outcome of the communication, and does not interfere with the choice of table or the time of the booking. In fact, once it has put the Customer and the Provider into direct communication, the CMS 100 is no longer involved in their contact, and its role has ended.

The phone call between the user and the service provider can be generated in any suitable way, e.g., by using the WTA (Wireless Telephony Application) layer of the WAP client. In this method, the CMS talks to the cellular units using the WAP protocol. When the right service provider is located, the CMS sends to him a message including a WTA command: dial the customer's number. Of course, different communication methods can be employed, but these are well understood by the skilled person, and therefore are not described herein, for the sake of brevity.

The CMS may charge its customer on any basis and by any suitable means. For instance, a customer may be billed for the assistance through his cellular phone bill. According to another preferred embodiment of the invention the service may be provided free of charge to the customer, since the airtime generated is an indirect revenue from the transaction. The provider, according to this particular preferred embodiment of the invention, may be charged a fixed fee per transaction.

As will be appreciated by the skilled person, it is necessary for the quality of service of the system to be high, that the information relative to the Provider be constantly kept up to date. According to a preferred embodiment of the invention the provider is responsible for sending to the CMS online updates as to its current location, availability and other relevant data that the CMS may be requiring. The geographic position is determined by a location facility, as described in Step 203 above, by may also be provided by the provider as data to the CMS, if the provider does not use a phone that is compatible with location systems. Additional data items are either keyed in by the provider, or sent to the CMS via an automatic device (e.g., a parking management system), or are relayed to a manned position facility that inputs them into the CMS database. The above characteristics and advantages of the invention will be further illustrated by the following examples.

### EXAMPLE 1

### Calling a Plumber

A pipe has burst and the house is flooded. The owner calls the CMS for emergency assistance. The CMS determines who are the plumbers nearer to the house, whether they are idle or in the middle of another job, how long it will take them to reach the house, based on traffic information, their experience with hot water leaks. etc. The CMS then picks the plumber that appears to be best suited for the job. It generates a conversation between the regular telephone line of the house and the cellular phone of the plumber, and leaves the rest to the customer and the plumber.

### EXAMPLE 2

### Finding a Date

Dating with strangers is a topic of actuality nowadays. In Japan devices have been marketed, which permit two owners of such devices, found in close proximity, to learn one about the willingness of the other to become acquainted, by pushing an “accept” or a “reject” button. The usefulness of such devices is however limited. The present invention permits to address much more complicated problems. For instance, a student finds himself alone in a strange city and wishes to visit an exhibition. He may find a companion for the visit to the exhibition by calling the CMS. The CMS then will put him into contact with the best found person (who has previously left his details in the CMS) based on parameters such as gender, section of the exhibition in which he is interested, planned visiting hours, etc. An anonymous telephone conversation, initiated by the CMS, may then let them determine whether they actually wish to meet and go to the exhibition together. Since the CMS does not need to know the names of the persons using the service, it is possible to remain anonymous if the conversation indicates that there is no compatibility between the two persons.

### EXAMPLE 3

### Finding a Parking Spot

Parking spots may be located according to the invention. In this example the driver who is looking for available parking space calls the CMS, which puts him into communication with a parking system. The parking system keeps track of available parking space, and advises the driver of available spots. Communication with the driver may be made via automatic synthesized voice systems or through a manned position. The parking system will offer the driver those parking spots which are in the area near the current location of the driver, as determined by the CMS with the help of the driver's phone provider.

### EXAMPLE 4

### Courier on Call

A person wishing to deliver an item from his home or office, or from any location where he may happen to be (e.g., a train station) will call the CMS and inquires about a courier. The CMS determines the nearest available courier and connects it with the caller. The courier may then agree with the customer on the time and place of pick-up, and will then pick up the item and deliver it.

### EXAMPLE 5

### Pizza Services

A person wishing to purchase piazza from specific sellers may define in his profile the identity of such servers. When he requires pizza. The CMS will search for the closes available pizza place, only within those defined by the user, and will connect the user with that which is the closest and which declares parameters that will lead to the pizza being delivered sooner.

### EXAMPLE 4

### Rooms for Rent

A person in need if a room in a hotel or bed-and-breakfast will be connected by the CMS to the rooms closest to his position or to the location where he plans to arrive.

While embodiments of the invention have been described by way of illustration, it will be understood that the invention can be carried out by persons skilled in the art with many modifications, variations and adaptations, without departing from its spirit or exceeding the scope of the claims.

1. A method for matching a customer and a Provider, comprising the steps of:
a) generating a database containing data relevant to the Provider;
b) updating said database so as to keep said data on the Provider up-to-date;
c) when a call is received from a customer, identifying the requirements of the customer;
d) identifying the nature of the request of the customer for a Provider;
e) searching said database for a Provider who fits best the requirements of the customer; and
f) when such best fit provider is found, generating a voice and/or data communication between said customer and said provider.

2. A method according to claim 1, wherein the requirements of the customer include his geographic location.

3. A method according to claim 1 or 2, wherein the data relevant to the Provider kept in the data base are selected from among availability status, geographical location and scheduled jobs.

4. A method according to claim 2, wherein the data relevant to the Provider kept in the data base comprise its location.

5. A method according to claim 1, wherein the data relevant to the Provider kept in the data base comprise status information.

6. A method according to claim 4, wherein the status information comprises an indication of availability.

7. A method according to claim 1, wherein the updating of the database is initiated by the Providers.

8. A method according to claim 1, wherein the updating of the database is initiated by the database by polling the Providers.

9. A method according to any one of claims 1 to 7, wherein the location of the customer is determined using location systems of the communication network from which the call of the customer is placed.

10. A method according to any one of claims 1 to 8, wherein the communication network is a cellular phone network.

11. A method according to any one of claims 1 to 7, wherein the customer uses a regular telephone line.

12. A method according to any one of claims 1 to 7 and 10, wherein the Provider uses a regular telephone line.

13. A method according to any one of claims 1 to 11, wherein the customer is in motion.

14. A method according to any one of claims 1 to 12, wherein the Provider is in motion.

15. A method according to any one of claims 1 to 11 and 13, wherein the customer is static.

16. A method according to any one of claims 1 to 12 and 14, wherein the Provider is static.

17. A method according to any one of claims 1 to 15, wherein the Provider is selected from among food providers, house services providers, personal services providers, delivery services, and information providers.

18. A system for matching a customer and a Provider, comprising:
a) a database containing data relevant to the Provider;
b) communication lines and means for updating said database so as to keep said data on the Provider up-to-date;
c) location apparatus for identifying the geographical location of the customer calling the system;
d) personnel or apparatus for identifying the nature of the request of the customer for a Provider;
e) searching software for searching said database for a Provider who fits best the requirements of the customer; and
f) dialing and switching means for generating a voice communication between said customer and said provider.
